(19) United States
(12) Patent Application Publication
(10) Pub. No.: US 2020/0403201 A1
(43) Pub. Date: Dec. 24, 2020

(54) APPARATUS AND METHOD FOR THERMAL RUNAWAY PROPAGATION PREVENTION

(71) Applicant: ALL CELL TECHNOLOGIES, LLC, CHICAGO, IL (US)

(72) Inventors: Said AL-HALLAJ, Chicago, IL (US); Benjamin SCHWEITZER, Seattle, WA (US); Samuel T. PLUNKETT, Chicago, IL (US)

(73) Assignee: ALL CELL TECHNOLOGIES, LLC, CHICAGO, IL (US)

(21) Appl. No.: 16/902,788

(22) Filed: Jun. 16, 2020

Related U.S. Application Data
(60) Provisional application No. 62/864,590, filed on Jun. 21, 2019.

(51) Int. Cl. H01M 2/12; H01M 2/10; H01M 10/653

(52) U.S. Cl. CPC H01M 2/1258; H01M 2/127; H01M 10/653; H01M 2/1077

(57) ABSTRACT

A thermal propagation prevention device and method for a battery pack including a plurality of battery cells. The device includes a liquid loaded material, such as a hydrogel or liquid loaded superabsorbent polymer, contained in a propagation arrestor configured to cover at Least one of the plurality of battery cells. The liquid loaded material is configured to phase change under heat from a rupture of the at least one of the plurality of battery cells and release a quenching vapor. The vapor further dilutes the electrolyte released from the at least one of the plurality of battery cells.

### CROSS REFERENCE TO RELATED APPLICATION

This application claims the benefit of U.S. provisional application, Ser. No. 62/864,590, filed on 21 Jun. 2019. The co-pending provisional application is hereby incorporated by reference herein in its entirety and is made a part hereof, including but not limited to those portions which specifically appear hereinafter.

### BACKGROUND OF THE INVENTION

This invention relates generally to thermal runaway prevention in battery packs and, more particularly, to an apparatus, materials, and methods for reducing or eliminating thermal runaway in battery packs.

Overheating in an individual cell of a multi-cell battery pack can have a domino effect of causing an overheating of adjacent cells in the battery pack. In addition, release of the cell electrolyte, e.g., organic solution with lithium salts materials, can result in combustion, which can increase the likelihood of additional cell overheating. There is a continuing need for thermal runaway propagation prevention in battery packs.

### SUMMARY OF THE INVENTION

A general object of the invention is to reduce or eliminate thermal runaway between battery cells of a battery module. The general object of the invention can be attained, at least in part, through a thermal propagation prevention device and method for a battery pack including a plurality of battery cells and a vapor releasing material in combination with the battery cells. The released vapor quenches any flame, reduces heat, and/or dilutes any released battery chemicals.

Embodiments of this invention include a propagation arrestor configured to cover at least one of the plurality of battery cells. The propagation arrestor encloses an electrolyte diluter material configured to release a vapor under heat or electrical field from a rupture of the at least one of the plurality of battery cells. The vapor desirably dilutes the electrolyte released from the at least one of the plurality of battery cells. In embodiments of this invention, a composite array, such as including heat absorbing microencapsulated phase change material, is disposed around and between the plurality of battery cells, and the propagation arrestor extends over the plurality of battery cells on one or more sides of the composite array.

In embodiments of this invention, the electrolyte diluter material comprises a hydrogel or superabsorbent polymer material. The hydrogel or superabsorbent polymer desirably is or includes a liquid loaded super absorbent material. The liquid can be water, including any desirable additives, such as for neutralizing the electrolyte. The vapor results from an evaporative phase change release from the heated hydrogel or superabsorbent.

In embodiments of this invention, the propagation arrestor extends over a terminal end of each of the plurality of battery cells. The propagation arrestor includes one or more openings facing the plurality of battery cells. The opening(s) can include a mesh cover, e.g., stainless steel mesh, to retain the electrolyte diluter material and allow electrolyte to enter the propagation arrestor. The propagation arrestor can further include a release opening configured to release a diluted electrolyte to a surrounding environment of the battery pack.

The invention also includes a battery pack including a plurality of battery cells, each including an electrolyte material, and a propagation arrestor extending over the plurality of battery cells. The propagation arrestor encloses an electrolyte diluter material configured to release an electrolyte dilution vapor under heat or electrical field from a rupture of one or more of the plurality of battery cells. A rupturable container can be used to further enclose a liquid loaded material.

The invention further includes a method of containment of rupturing battery cells. The method includes directing thermal energy and electrolyte from a rupturing battery cell toward a stored liquid (e.g., a hydrogel or superabsorbent polymer); heating and evaporating the stored liquid with the thermal energy; and releasing vapor from the stored liquid to dilute the electrolyte. The method preferable further includes a step of releasing diluted electrolyte to a surrounding environment.

Embodiments of this invention can further include an actuation mechanism configured to apply heating or electrical field to rupture the electrolyte diluter material. The actuation mechanism can be incorporated into or with a battery control or monitoring system to detect the cell failure and release the electrolyte diluter. The actuation mechanism can incorporate a heating element or electric field generation element in combination with the electrolyte diluter material, such as to rupture any containment film/pack and/or cause direct physical absorbent polymer change.

Other objects and advantages will be apparent to those skilled in the art from the following detailed description taken in conjunction with the appended claims and drawings.

### BRIEF DESCRIPTION OF THE DRAWINGS

FIG. 1 is a perspective, partial sectional view of a battery module according to one embodiment of this invention.

FIG. 2. is a perspective, partial sectional view of a battery module according to one embodiment of this invention.

FIG. 3 a perspective view of a battery module according to one embodiment of this invention.

FIG. 4 is a sectional view of the module of FIG. 3.

FIG. 5 is a sectional view of a battery module according to another embodiment of this invention.

FIG. 6 is a partial sectional view of a battery module according to another embodiment of this invention.

### DESCRIPTION OF THE INVENTION

The present invention provides an apparatus and method for suppressing thermal runaway in battery packs. The invention incorporates a hydrated absorbent material that absorbs thermal energy of a cell failure through a liquid-vapor phase change. In embodiments of this invention, battery cells (e.g., lithium-ion cells) in a battery pack are placed in contact, generally direct contact, with the liquid-vapor phase change material or a vessel thereof. The material spreads heat throughout the pack, avoiding hot spots that can trigger additional failures. In addition, the phase change material is preferably an electrolyte diluter, whereby liquid and/or vapor released from the absorbed phase change material is desirably used to quench flames and/or dilute electrolyte released from the failing battery cell.

In embodiments of this invention, the electrolyte diluter and/or phase change material is a hydrogel or superabsorbent polymer material or other liquid loaded absorbent material such as any suitable hydrogel polymer or super absorbent polymer (SAP). Exemplary hydrophilic, or water-absorbing, polymer materials include, without limitation, poly-acrylic acids, such as acrylic acid copolymers of an acrylic acid and a salt. Suitable materials include alkali metal salts of polyacrylic acids; polyacrylamides; polyvinyl alcohol; ethylene maleic anhydride copolymers; polyvinyl ethers; hydroxypropylcellulose; polyvinyl morpholinone; polymers and copolymers of vinyl sulfonic acid, polyacrylates, polyacrylamides, polyvinyl pyridine; and the like. Other suitable polymers include hydrolyzed acrylonitrile grafted starch, acrylic acid grafted starch, carboxy-methyl-cellulose, isobutylene maleic anhydride copolymers, and mixtures thereof. Further suitable polymers include inorganic polymers, such as polyphosphazene, and the like.

The phase change material can be loaded with water or any suitable evaporative liquid. The material or liquid can include additives or additional materials, such as hydrolyzed salts, for improving heat absorption.

The electrolyte diluter and/or phase change material of this invention can be integrated with the battery pack and cells in any suitable structure or configuration, depending on need, the array configuration of battery pack/cell, the amount needed, etc. The phase change material can be, for example a loose and/or microencapsulated powder, incorporated in a composite material or array structure, and/or incorporated in a pouch or sheet. The liquid-vapor phase change material can also be used in combination with other known phase change materials, such as meltable (solid-liquid) materials including microencapsulated wax materials.

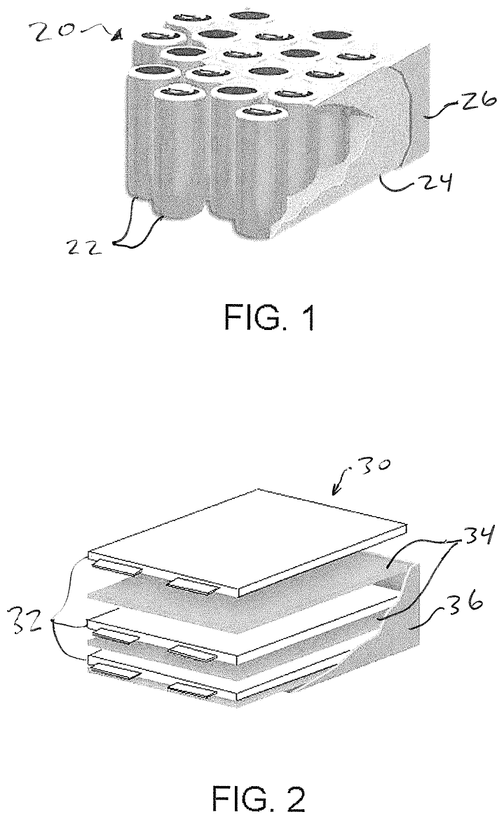

FIG. 1 shows a battery cell array 20 according to one embodiment of this invention. Cells 22 are contained by, and at least partially surrounded by, a composite array structure 24. The structure 24 can be any suitable material. For example, the structure 24 can include an outer shell 26 with loosely packed phase change material (e.g., a microencapsulated powder). The structure 24 can also be a lattice member formed of various screen or foam materials such as graphite foam and metal foams such as aluminum foam and particularly open-celled forms of such foams, for example, where the porous material includes or contains the liquid-vapor phase change material of this invention. The porous material can additionally include or contain an additional phase change material, such as microencapsulated wax, for temperature regulation during normal (pre-failure) battery use.

FIG. 2 illustrates a further embodiment of a battery pack 30 according to one embodiment of this invention. Planar battery cells 32 are stacked and separated by planar phase change material ‘sheets’ 34, all within housing 36. The sheets 34 can be a composite lattice material, such as described for FIG. 1, or a pouch or other envelope/vessel that includes the phase change material. The pouch is desirably rupturable or ventable to release vapor as an electrolyte diluter.

In additional embodiments of this invention, the liquid-vapor phase change material is incorporated in a flexible woven or other fabric composite, such as described in U.S. Pat. No. 10,005,941, herein incorporated by reference.

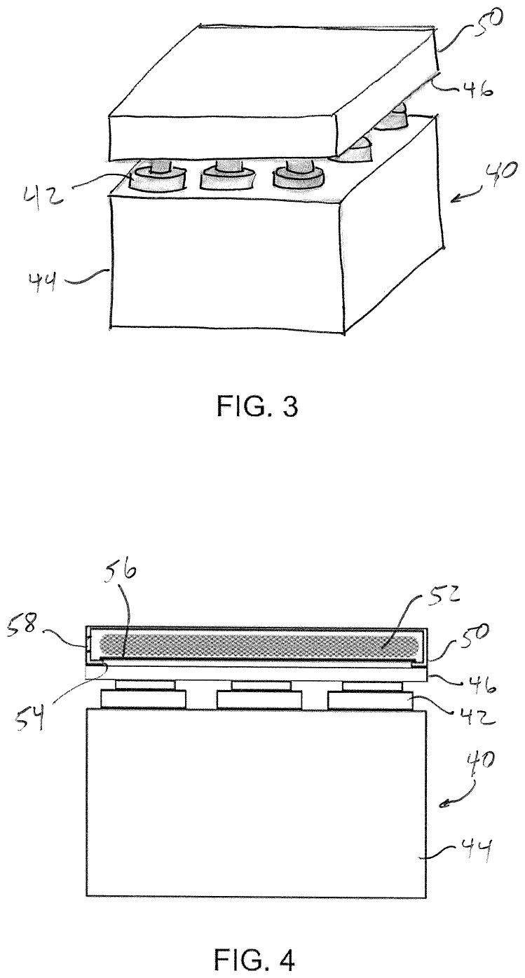

FIGS. 3 and 4 illustrate a further embodiment, wherein a battery module 40 includes a propagation arrestor 50. The battery module includes six battery cells 42, enclosed in matrix 44, such as any matrix discussed above, and a current collector 46 in combination with terminal ends 48 of the cells 42. The propagation arrestor 50 desirably covers terminal ends (e.g., the positive terminal end) of one or more of the cells. The placement and configuration of the propagation arrestor can vary depending on the size, shape, and configuration of the battery module 40.

As shown in FIG. 4, the propagation arrestor 50 contains or encloses an electrolyte diluter material 52 (e.g., a hyrdogel or superabsorbent polymer) configured to release a vapor under heat from a rupture of the at least one of the plurality of battery cells. The propagation arrestor 50 includes an opening 54 on a side facing the battery cells 42 through which byproducts (e.g., heat, diluted electrolyte, etc.) of a rupturing cell can pass. A single opening 54 is shown in FIG. 4. Alternatively each cell, or collection of cells, can have a separate and corresponding opening. A mesh 56, such as steel, fiberglass, Kevlar, etc., can be included over the opening 54 to secure the electrolyte diluter material 52 within the propagation arrestor 50 while allowing passage for rupture byproducts.

In embodiments of this invention the electrolyte diluter material 52 is a loose particulate or other form within a chamber of the propagation arrestor, and held therein by the mesh 56. A meltable or otherwise rupturable film can be included over the mesh to avoid premature evaporation during normal battery use. In other embodiments, a pouch is disposed around and enclosing the electrolyte diluter material within the propagation arrestor. The pouch is desirably sealed to maintain the material and avoid evaporation. During use, in case of thermal runaway, the electrolyte diluter acts as a thermal fuse by absorbing heat energy, breaking down and/or releasing water vapor from the phase change, which will quench a failing cell due to extremely high latent of evaporation (˜3,600 J/g vs ˜240/J/g max for wax).

Whether in a pouch, microencapsulated, or otherwise contained in the propagation arrestor, the vapor released from the absorbent material of the electrolyte diluter dilutes the electrolyte vented into the propagation arrestor from the failed cell and desirably prevents its combustion. In embodiments of this invention, the liquid phase of the electrolyte diluter further includes additive for neutralizing the electrolyte. The internal containment structure, e.g., pouch, can includes a rupture area, such as including a line or area of weakness, which directs rupture in a particular direction, such as toward the cells.

In further embodiments of this invention, such as shown in FIGS. 3 and 4, the propagation arrestor includes a pressure relief opening 58 to release the vapor/electrolyte mixture safely to the environment outside of the battery module and propagation arrestor. The opening 58 can be rupturable or include any suitable valve structure.

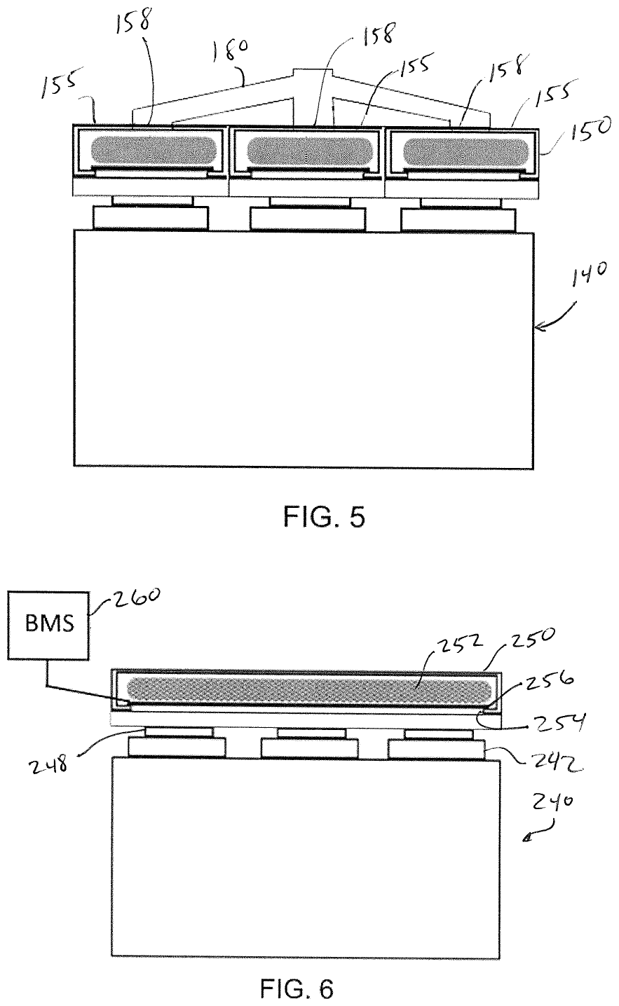

As will be appreciated various sizes, shapes, and configurations are available for the propagation arrestor and components thereof, such as depending on need and the components and configuration of the battery module and/or cells. For example, FIG. 5 shows a battery module 140 where the propagation arrestor 150 is divided into separate arrestor chambers 155, each for one cell or a subset (e.g., pairs) of battery cells. The divided arrestor chambers further limit the spread of the cell rupture byproducts to neighboring cells to reduce or eliminate thermal runaway. Each arrestor chamber 155 can include a pressure relief opening 158, or optionally include a channel structure or manifold 180 to collect and direct the vapor/electrolyte mixture to a common outlet in a predetermined position and direction from the module 140.

FIG. 6 illustrates a battery module system according to another embodiment of this invention, wherein a battery module 240 includes a propagation arrestor 250. The battery module includes six battery cells 242, enclosed in matrix 244, such as any matrix discussed above, and a current collector 246 in combination with terminal ends 248 of the cells 242. The propagation arrestor 250 contains or encloses an electrolyte diluter material 252 (e.g., a hydrogel or liquid loaded superabsorbent polymer) configured to release a vapor under heat. The propagation arrestor 250 includes an opening 254 on a side facing the battery cells 242 through which byproducts (e.g., heat, diluted electrolyte, etc.) of a rupturing cell can pass. A steel mesh 256 is included over the opening 254 to secure the electrolyte diluter material 252 within the propagation arrestor 250 while allowing passage for rupture byproducts and/or electrolyte diluter vapor.

FIG. 6 further illustrate a battery management system (BMS) 260 in activating combination with the propagation arrestor 250 and/or electrolyte diluter material 252. The BMS 260 includes a control strategy or algorithm, stored as software encoded instructions on a recordable medium, to release or otherwise activate, either fully or to expedite the process, the electrolyte diluter material 252 upon a rupture. In embodiments of this invention, the BMS 260 can apply heat to release the electrolyte diluter material 252. As an example, the BMS 260 can be electrically connected to a heating or heatable element to release or expedite release of the electrolyte diluter material 252. In another embodiment, the BMS 260 applies an electric field about the electrolyte diluter material 252 to cause or expedite vapor release. The heat and/or electric field can, for example, rupture any film enclosing the electrolyte diluter material 252 or open a pore structure of the electrolyte diluter mesh material 252. The BMS 260 can be connected to heating elements and/or electrodes within the propagation arrestor 250 and/or electrolyte diluter material 252. As shown in FIG. 6, the BMS 260 is connected to the mesh 256 that also acts as the heating element or electrode. Having a heating element or field generating electrodes across the propagation arrestor 250 can help ensure a faster and full release of vapor across the entire electrolyte diluter material 252. The heating elements or electrodes can be placed in any position or configuration within the propagation arrestor, depending on need.

Thus, the invention provides an apparatus and method for suppressing thermal runaway in battery packs. Water-filled superabsorbent or other hydrogel or superabsorbent polymer can be encapsulated or otherwise enclosed adjacent the battery pack to absorb thermal energy and/or dilute electrolyte release, thereby keeping a failed battery cell from triggering further failures.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention. The invention claims any, some, or all features of novelty described, suggested, referred to, exemplified, or shown herein, and corresponding systems, components, and other devices, and associated methods of manufacturing and implementation.

What is claimed is:

1. A thermal propagation prevention device for a battery pack including a plurality of battery cells, the device comprising a propagation arrestor configured to cover at least one of the plurality of battery cells, the propagation arrestor enclosing an electrolyte diluter material configured to release a vapor under heat from a rupture of the at least one of the plurality of battery cells.

2. The device of claim 1, wherein the vapor dilutes the electrolyte released from the at least one of the plurality of battery cells.

3. The device of claim 1, wherein the electrolyte diluter material comprises a hydrogel or superabsorbent polymer material.

4. The device of claim 1, wherein the propagation arrestor extends over a terminal end of each of the plurality of battery cells.

5. The device of claim 1, wherein the propagation arrestor comprises an opening facing the at least one of the plurality of battery cells.

6. The device of claim 5, wherein the opening comprises a mesh cover configured to retain the electrolyte diluter material and allow electrolyte to enter the propagation arrestor.

7. The device of claim 5, further comprising a release opening configured to release a diluted electrolyte to a surrounding environment of the battery pack.

8. The device of claim 5, further comprising an actuation mechanism configured to apply heating or electrical field to rupture the electrolyte diluter material.

9. The device of claim 1, further comprising a composite array disposed around and between the plurality of battery cells, wherein the propagation arrestor extends over the plurality of battery cells on a side of the composite array.

10. A battery pack comprising:
a plurality of battery cells, each including an electrolyte material;
a propagation arrestor extending over the plurality of battery cells, the propagation arrestor enclosing an electrolyte diluter material configured to release an electrolyte dilution vapor under heat from a rupture of one or more of the plurality of battery cells.

11. The battery pack of claim 10, wherein the electrolyte diluter material comprises a hydrogel or superabsorbent polymer material.

12. The battery pack of claim 11, wherein the hydrogel or superabsorbent polymer comprises a liquid loaded super absorbent material.

13. The battery pack of claim 11, further comprising a rupturable container enclosing the hydrogel or superabsorbent polymer.

14. The battery pack of claim 10, wherein the propagation arrestor comprises an opening facing the plurality of battery cells.

15. The battery pack of claim 14, wherein the opening comprises a mesh cover configured to retain the electrolyte diluter material and allow electrolyte to enter the propagation arrestor.

16. The battery pack of claim 14, further comprising a release opening configured to release a diluted electrolyte to a surrounding environment of the battery pack.

17. The battery pack of claim 11, further comprising a composite array disposed around and between the plurality of battery cells, the composite array including a heat absorbing microencapsulated phase change material.

18. A method of containment of rupturing battery cells, the method comprising:
directing thermal energy and electrolyte from a rupturing battery cell toward a stored liquid;
heating and evaporating the stored liquid with the thermal energy; and
releasing vapor from the stored liquid to dilute the electrolyte.

19. The method of claim 19, further comprising releasing diluted electrolyte to a surrounding environment.

20. The method of claim 19, wherein the stored liquid is contained in a hydrogel or superabsorbent polymer.
